(19) United States
(12) Patent Application Publication
(10) Pub. No.: US 2008/0196613 A1
(43) Pub. Date: Aug. 21, 2008

(54) PRINT PLATE, A SPACER-PRINTING APPARATUS HAVING THE PRINT PLATE AND A METHOD OF PRINTING A SPACER BY USING THE PRINT PLATE

(76) Inventors: Byoung-Hun Sung, Seoul (KR); Bong-Sung Seo, Yongin-si (KR); Baek-Kyun Jeon, Yongin-si (KR)

Correspondence Address: F. CHAU & ASSOCIATES, LLC, 130 WOODBURY ROAD, WOODBURY, NY, 11797, US

(21) Appl. No.: 11/949,303

(22) Filed: Dec. 3, 2007

(30) Foreign Application Priority Data
Feb. 15, 2007 (KR) 2007-16202

(51) Int. Cl. B41F 3/00; B41N 1/00; B41F 1/34

(52) U.S. Cl. 101/250; 101/395; 101/485

(57) ABSTRACT

A print plate includes a surface including a central region and a peripheral region surrounding the central region, a panel print section and an alignment print section. The panel print section includes a plurality of panel spacer recesses disposed in the central region. The alignment print section includes a plurality of alignment spacer recesses disposed in the peripheral region. The alignment spacer recesses are spaced apart from each other.

### CROSS-REFERENCE TO RELATED APPLICATION

This application claims priority under 35 U.S.C. §119 to Korean Patent Application No. 2007-16202, filed on Feb. 15, 2007 in the Korean Intellectual Property Office (KIPO), the disclosure of which is incorporated by reference herein in its entirety.

### BACKGROUND OF THE INVENTION

1. Technical Field

The present invention relates to a print plate, and more particularly, to a print plate for printing an alignment mark, a spacer-printing apparatus having the print plate, and a method of printing a spacer by using the print plate.

2. Discussion of the Related Art

A liquid crystal display (LCD) apparatus has become one of the most widely used flat panel displays. For example, the LCD apparatus is commonly found in a variety of electronic devices such as flat screen televisions, laptop computers, cellular phones, and digital cameras.

The LCD apparatus includes an LCD panel that displays an image by changing the optical transmissivity of a liquid crystal and a backlight assembly that is disposed under the LCD panel to provide the LCD panel with light.

The LCD panel includes a first substrate, a second substrate, a liquid crystal layer, a seal line and a plurality of spacers. The first substrate includes a thin-film transistor (TFT). The second substrate includes color filters. The liquid crystal layer is disposed between the first and second substrates. The seal line is disposed between the first and second substrates to seal the liquid crystal layer. The spacers maintain a separation distance between the first and second substrates.

To form the liquid crystal layer, a variety of methods such as a liquid crystal dropping method and a liquid crystal injection method, may be employed. According to the liquid crystal dropping method, the seal line and the spacers are formed on a second base substrate of the second substrate. The liquid crystal is dropped onto the second base substrate having the seal line and the spacers formed thereon. Then, the first and second substrates are assembled with each other in a vacuum chamber.

The spacers can be interposed between the first and second substrates by employing a printing method. In this method, spacers received in recesses of a print plate are printed onto an alignment plate by a print roller to form an alignment mark, a position of the alignment mark is stored, and the second base substrate is aligned using the alignment mark. Then, spacers received in recesses of the print plate are printed onto the second base substrate by the print roller.

However, when the recesses used to form the alignment mark are not uniformly filled, the spacers therein can be tilted to a side by a filling blade, thereby causing an outline of the alignment mark to become difficult to discern. As a result, it can be difficult to accurately align the second base substrate.

Accordingly, there exists a need for forming a clear outline of an alignment mark so that a second base substrate can be accurately aligned.

### SUMMARY OF THE INVENTION

In an exemplary embodiment of the present invention, a print plate includes a surface including a central region and a peripheral region surrounding the central region, a panel print section and an alignment print section.

The panel print section includes a plurality of panel spacer recesses disposed in the central region. The alignment print section includes a plurality of alignment spacer recesses disposed in the peripheral region. The alignment spacer recesses are spaced apart from each other. The alignment spacer recesses may be arranged along a first direction and a second direction crossing the first direction. The first and second directions may be substantially perpendicular to each other.

The alignment spacer recesses may be arranged to have a cross shape. The alignment print section may further include a central spacer recess formed at a center of the cross shape. The alignment spacer recesses may be formed along a plurality of lines in the first direction and along a plurality of lines in the second direction.

Each of the alignment spacer recesses has a dot shape. The dot shape may be circular or tetragonal. The surface may have a rectangular shape, and the alignment print section may be formed in at least two corners of the surface having the rectangular shape.

Each of the alignment spacer recesses may have substantially the same size as each of the panel spacer recesses. Each of the alignment spacer recesses may receive about ten to about thirty spacers.

In an exemplary embodiment of the present invention, the spacer-printing apparatus includes a print plate, an alignment plate, a print roller and a position-storing unit.

The print plate includes a surface including a central region and a peripheral region surrounding the central region, a panel print section and an alignment print section. The panel print section includes a plurality of panel spacer recesses disposed in the central region. The alignment print section includes a plurality of alignment spacer recesses disposed in the peripheral region. The alignment plate is disposed adjacent to the print plate. The print roller rolls on the print plate and the alignment plate to print spacers received in the alignment spacer recesses of the print plate onto the alignment plate to form an alignment mark on the alignment plate. The position-storing unit is disposed over the alignment plate. The position-storing unit stores a position of the alignment mark.

The spacer-printing apparatus may further include a print plate stage and an alignment plate stage. The print plate stage supports the print plate and the alignment plate stage supports the alignment plate. The position-storing unit may include at least one camera for taking a picture of the position of the alignment mark.

In an exemplary embodiment of the present invention, a method of printing a spacer includes forming an alignment mark including a plurality of spacer dots on an alignment plate, storing a position of the alignment mark, aligning a target substrate by using the position of the alignment mark, and printing spacers received in panel spacer recesses of a print plate onto the target substrate.

Forming the alignment mark includes filling alignment spacer recesses of the print plate with spacers, and rolling a print roller on the print plate and the alignment plate to print the spacers in the alignment spacer recesses onto the alignment plate to form the alignment mark.

Storing the position of the alignment mark includes taking a picture of the alignment mark and storing the position of the alignment mark.

Aligning the target substrate includes separating the alignment plate from an alignment plate stage, loading the target substrate onto the alignment plate stage, and aligning the target substrate so that a target alignment mark on the target substrate coincides with the stored position of the alignment mark.

Printing the spacers includes filling the panel spacer recesses of the print plate with the spacers, and rolling a print roller on the print plate and the target substrate to print the spacers in the panel spacer recesses of the print plate onto the target substrate.

### BRIEF DESCRIPTION OF THE DRAWINGS

The above and other features of the present invention will become more apparent by describing in detail exemplary embodiments thereof with reference to the accompanying drawings, in which:

FIG. 1 is a perspective view illustrating a spacer-printing apparatus according to an exemplary embodiment of the present invention;

FIG. 2 is a plan view illustrating a first surface of a print plate in FIG. 1;

FIG. 3 is a perspective view illustrating a step for printing an alignment mark onto an alignment plate by using a print roller in FIG. 1 according to an exemplary embodiment of the present invention;

FIG. 4 is a perspective view illustrating a step for storing a position of the alignment mark in FIG. 3 in a position-storing unit according to an exemplary embodiment of the present invention;

FIG. 5 is a perspective view illustrating a step for aligning a target substrate by using the position of the alignment mark in FIG. 4 according to an exemplary embodiment of the present invention;

FIG. 6 is a perspective view illustrating a step for printing a spacer onto the target substrate in FIG. 5 according to an exemplary embodiment of the present invention;

FIG. 7 is a plan view illustrating an alignment print section on the print plate in FIG. 2;

FIG. 8 is an enlarged plan view illustrating a portion A in FIG. 7;

FIG. 9 is a plan view illustrating an alignment print section according to an exemplary embodiment of the present invention;

FIG. 10 is a plan view illustrating an alignment print section according to an exemplary embodiment of the present invention; and

FIG. 11 is a plan view illustrating an alignment print section according to an exemplary embodiment of the present invention.

### DESCRIPTION OF EXEMPLARY EMBODIMENTS

Exemplary embodiments of the invention are described more fully hereinafter with reference to the accompanying drawings. This invention may, however, be embodied in many different forms and should not be construed as limited to the embodiments set forth herein. It will be understood that when an element or layer is referred to as being “on”, “connected to” or “coupled to” another element or layer, it can be directly on, connected or coupled to the other element or layer or intervening elements or layers may be present.

A spacer-printing apparatus according to an exemplary embodiment of the present invention will now be described.

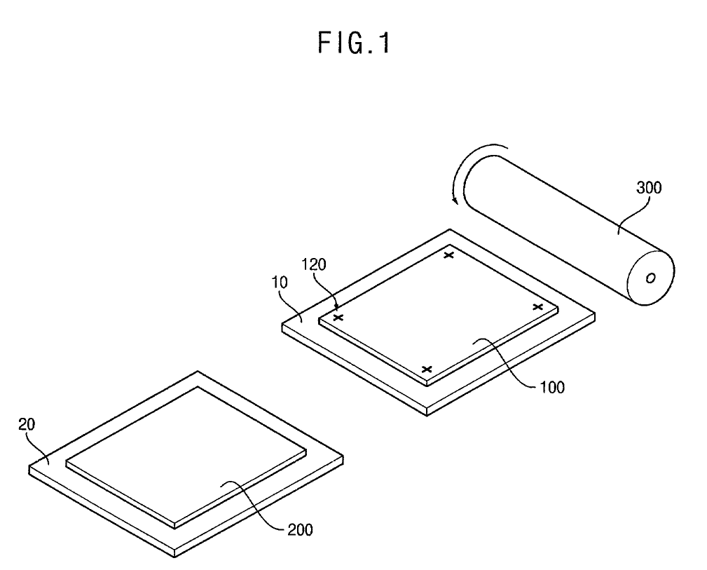

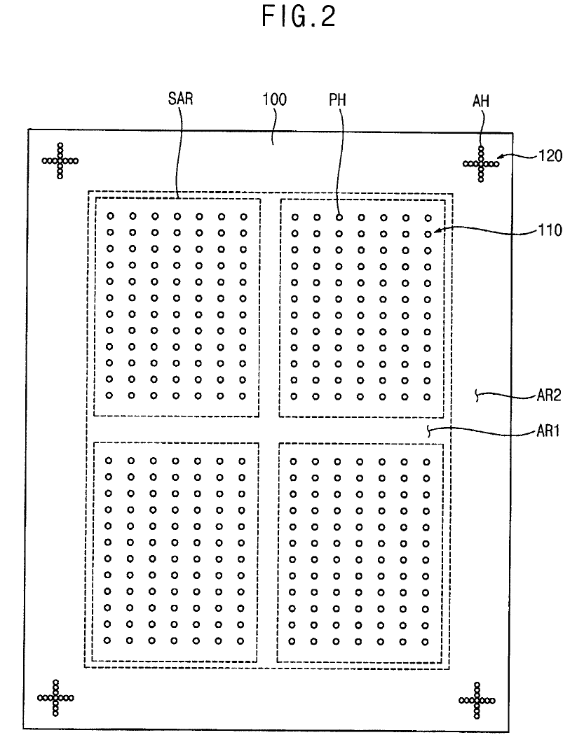

FIG. 1 is a perspective view illustrating a spacer-printing apparatus according to an exemplary embodiment of the present invention, and FIG. 2 is a plan view illustrating a first surface of a print plate in FIG. 1.

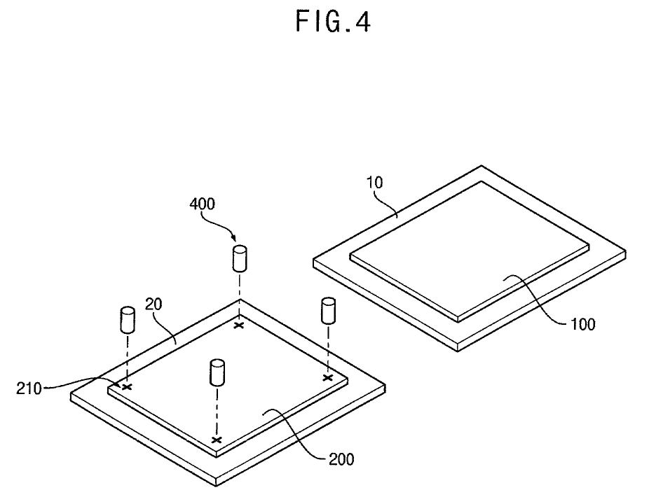

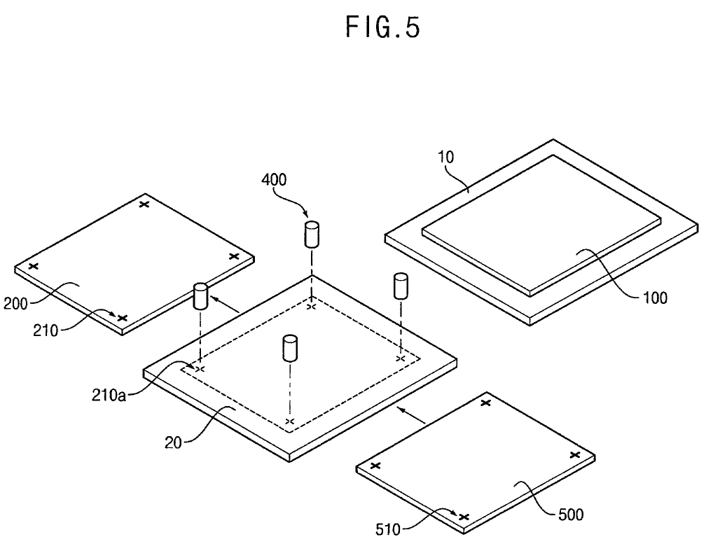

The spacer-printing apparatus includes a print plate stage 10, an alignment plate stage 20, a print plate 100, an alignment plate 200, a print roller 300, and a position-storing unit 400 (shown in FIGS. 4 and 5). The position-storing unit 400 will be explained referring to FIGS. 4 and 5.

The print plate stage 10 has, for example, a plate shape. The print plate stage 10 supports the print plate 100. The alignment plate stage 20 has, for example, a plate shape. The alignment plate stage 20 is disposed such that the alignment plate stage 20 is adjacent to the print plate stage 10. The alignment plate stage 20 supports the alignment plate 200.

The print plate 100 is disposed on the print plate stage 10. The print plate 100 has, for example, a plate shape, a tetragonal shape when viewed on a plan, and a rectangular shape when viewed on a plan.

The print plate 100 includes a panel print section 110 and an alignment print section 120. The panel print section 110 includes a plurality of panel spacer recesses PH formed in a central region AR1 of a surface of the print plate 100. The alignment print section 120 includes a plurality of alignment spacer recesses AH formed in a peripheral region AR2 surrounding the central region AR1. Each of the alignment spacer recesses AH has a dot shape, and the alignment spacer recesses AH are separated from each other.

The alignment spacer recesses AH are arranged along a first direction and a second direction substantially perpendicular to the first direction. The print plate 100 will be explained in more detail referring to FIGS. 2, 6 and 7.

The alignment plate 200 is disposed on the alignment plate stage 20. The alignment plate 200 has, for example, a plate shape, a tetragonal shape when viewed on a plan, and a rectangular shape when viewed on a plan. The alignment plate 200 has, for example, substantially the same shape as the print plate 100.

The print roller 300 prints spacers received in the panel spacer recesses PH and the alignment spacer recesses AH onto the alignment plate 200 or a target substrate 500 (shown in FIGS. 5 and 6). The target substrate 500 will be explained referring to FIGS. 5 and 6.

The print roller 300 has, for example, a cylindrical shape. The print roller 300 is rolled to move. The print plate 100 and the alignment plate 200 are disposed adjacent to each other along a printing direction.

The position-storing unit 400 is disposed over the alignment plate 200. The position-storing unit 400 stores a position of an alignment mark printed on the alignment plate 200 by the print roller 300. For example, the position-storing unit 400 includes at least one camera for taking a picture of the alignment mark.

A method of printing a spacer according to an exemplary embodiment of the present invention will now be described.

Referring to FIGS. 1 and 2, the alignment spacer recesses AH of the print plate 100 are filled with a plurality of spacers. The panel spacer recesses PH of the print plate 100 may also be filled with a plurality of spacers.

The process for filling the alignment spacer recesses AH and the panel spacer recesses PH with the spacers is as follows.

The spacers are sprayed onto the print plate 100 by a spacer sprayer (not shown). For example, the spacers are sprayed onto an end portion of the print plate 100.

The spacers are dipped in an ink having viscosity. The ink may be hardened when heated. For example, white ink such as melamine resin or polyester resin, etc. may be employed as the ink. Each of the spacers has a spherical shape of which a diameter is in a range of about 3 μm to about 5 μm.

When the spacers are sprayed onto the surface of the print plate 100, the spacers fill in the alignment spacer recesses AH and the panel spacer recesses PH of the print plate 100. A filling blade is used to fill the recesses AH and PH with the spacers.

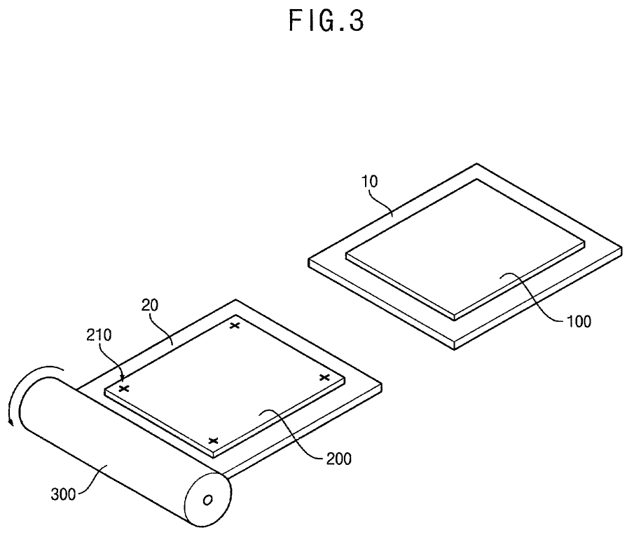

FIG. 3 is a perspective view illustrating a step for printing an alignment mark onto the alignment plate 200 by using the print roller 300 in FIG. 1 according to an exemplary embodiment of the present invention.

Referring to FIGS. 2 and 3, the spacers in the alignment spacer recesses AH are printed onto the alignment plate 200 by rolling the print roller 300 on the print plate 100 and the alignment plate 200 in a print direction.

The spacers in the alignment spacer recesses AH form an alignment mark 210 on the alignment plate 200. The alignment mark 210 includes spacer dots corresponding to the alignment spacer recesses AH.

FIG. 4 is a perspective view illustrating a step for storing a position of the alignment mark 210 in the position-storing unit 400 according to an exemplary embodiment of the present invention.

Referring to FIG. 4, the position-storing unit 400 stores a position of the alignment mark 210.

The position-storing unit 400 includes, for example, a camera and a main system. The camera is disposed over the alignment plate 200 to take a picture of the alignment mark 210 formed on the alignment plate 200. The main system is electrically connected to the camera to receive and store information regarding the position of the alignment mark 210.

FIG. 5 is a perspective view illustrating a step for aligning a target substrate by using the position of the alignment mark 210 according to an exemplary embodiment of the present invention.

Referring to FIG. 5, the alignment plate 200 is separated from the alignment plate stage 20, and a target substrate 500 is loaded onto the alignment plate stage 20. For example, the target substrate 500 may be a color filter substrate of a liquid crystal display (LCD) panel.

When the target substrate 500 is disposed on the alignment plate stage 20, the target substrate 500 is aligned by using the position information of the alignment mark 210, which is stored in the position-storing unit 400.

In detail, a target alignment mark 510 is formed on a surface of the target substrate 500. A position of the target alignment mark 510 corresponds to the alignment mark 210. When the target alignment mark 510 coincides with the alignment mark 210, the target substrate 500 is aligned with respect to the alignment plate stage 20.

FIG. 6 is a perspective view illustrating a step for printing a spacer onto the target substrate 500 according to an exemplary embodiment of the present invention.

Referring to FIGS. 2 and 6, the spacers in the panel spacer recesses PH of the print plate 100 are printed onto the target substrate 500.

In detail, the panel spacer recesses PH of the print plate 100 are filled with a plurality of spacers. The alignment spacer recesses AH of the print plate 100 may also be filled with a plurality of spacers.

The spacers in the panel spacer recesses PH are printed onto the target substrate 500 by rolling the print roller 300 on the print plate 100 and the target substrate 500 in the print direction.

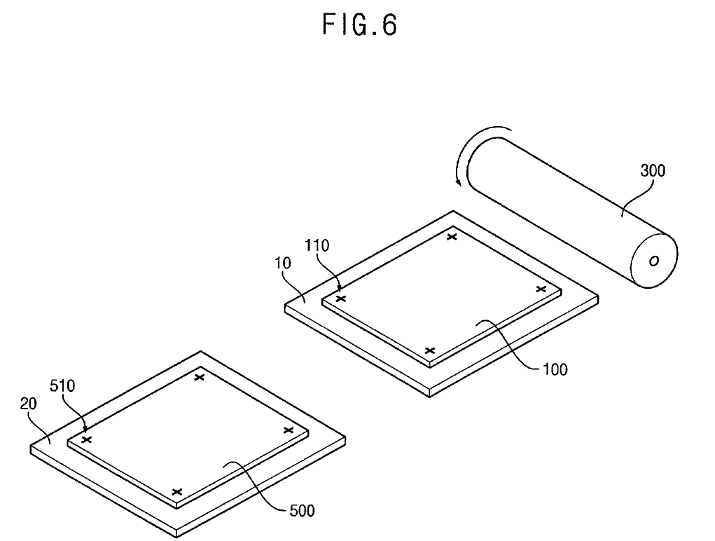

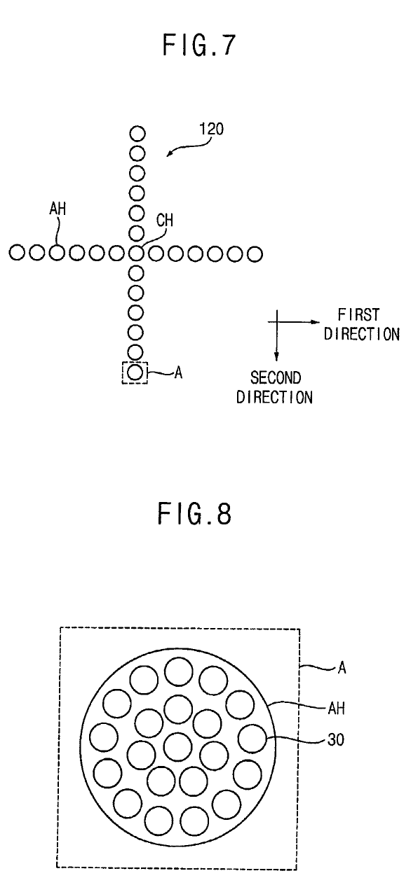

FIG. 7 is a plan view illustrating the alignment print section 120 on the print 100 plate in FIG. 2.

The print plate 100 will now be explained in detail referring to FIGS. 2, 6 and 7.

The print plate 100 includes the panel print section 110 and the alignment print section 120.

The panel print section 110 is formed in the central region AR1 of the print plate 100. The panel print section 110 includes the plurality of panel spacer recesses PH spaced apart from each other. The panel spacer recesses PH may correspond to one target substrate 500. Alternatively, the panel spacer recesses PH may correspond to a plurality of target substrates 500.

In detail, the central region AR1 may include a plurality of sub-regions SAR, each of which respectively corresponds to the target substrates 500. The panel spacer recesses PH in each of the sub-regions SAR are separated from each other by a uniform separation distance. For example, the central region AR1 includes four sub-regions SAR.

The alignment print section 120 is formed in the peripheral region AR2 of the print plate 100. The alignment print section 120 includes the plurality of alignment spacer recesses AH separated from each other. The alignment print sections 120 are formed in at least two corners of the print plate 100. For example, the alignment print sections 120 are formed at two diagonal corners of the print plate 100. Alternatively, the alignment print sections 120 may be formed at four corners of the print plate 100.

The alignment spacer recesses AH are arranged along a first direction and a second direction crossing the first direction. For example, the second direction is substantially perpendicular to the first direction. In detail, the alignment spacer recesses AH are arranged in a cross shape when viewed on a plan.

The alignment print section 120 may include a center spacer recess CH formed at a region where the alignment spacer recesses AH arranged in the first direction meet the alignment spacer recesses AH arranged in the second direction. In short, the center spacer recess CH is disposed at the center of the cross shape.

FIG. 8 is an enlarged plan view illustrating a portion A in FIG. 7.

Referring to FIG. 8, each of the alignment spacer recesses AH and the center spacer recess CH have a sufficient size for receiving a plurality of spacers 30. The alignment spacer recesses AH and the center spacer recess CH may have substantially the same size as the panel spacer recesses PH. For example, each of the alignment spacer recesses AH and the center spacer recesses CH has a size for receiving about ten to about thirty spacers.

Each of the alignment spacer recesses AH and the center spacer recess CH has a circular shape in the plan view.

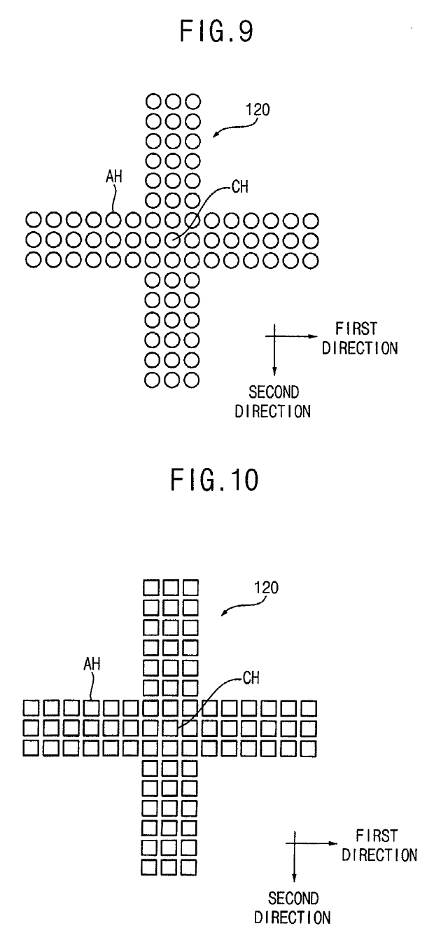

FIG. 9 is a plan view illustrating an alignment print section according to an exemplary embodiment of the present invention.

Referring to FIG. 9, the alignment print section 120 includes a plurality of alignment spacer recesses AH arranged in a plurality of lines.

In detail, the alignment spacer recesses AH are arranged in a plurality of lines along the first direction, and in a plurality of lines along the second direction. The number of lines of the first direction, along which the alignment spacer recesses AH are arranged, and the number of lines of the second direction, along which the alignment spacer recesses AH are arranged, are the same as each other. For example, the alignment spacer recesses AH are arranged in three lines along the first direction and the second direction, respectively.

FIG. 10 is a plan view illustrating alignment spacer recesses according to an exemplary embodiment of the present invention.

Referring to FIG. 10, the alignment print section 120 may have a plurality of alignment spacer recesses AH, each of which has a non-circular shape. For example, each of the alignment spacer recesses AH has a rectangular shape, or a square shape.

Alternatively, each of the alignment spacer recesses AH may have other shapes. For example, each of the alignment spacer recesses AH may have a polygonal shape such as a pentagonal shape, a hexagonal shape, etc.

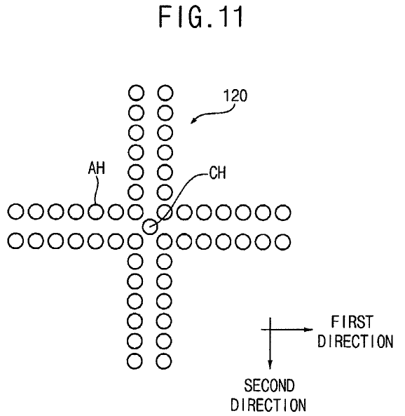

FIG. 11 is a plan view illustrating an alignment print section according to an exemplary embodiment of the present invention.

Referring to FIG. 11, a central spacer recess CH may be formed in between lines, along which the alignment spacer recesses AH are arranged.

In detail, when the alignment spacer recesses AH are arranged along two lines in the first direction, and along two lines in the second direction, the central spacer recess CH is formed in between the lines along which the alignment spacer recesses AH are arranged.

The alignment print section 120 may have various shapes not described above.

According to an exemplary embodiment of the present invention, the alignment print section 120 includes a plurality of alignment spacer recesses AH having a dot shape and being spaced apart from each other. Therefore, when the spacers 30 are completely filled in the alignment spacer recesses AH, a tilting of the spacers to a side by a filling blade is prevented.

For example, when the alignment print section 120 is formed to have an integrated recess like a conventional alignment print section, the spacers can be tilted to a side along a moving direction of a filling blade. As a result, the outline of the alignment mark 210 formed on the alignment plate 200 becomes ambiguous.

However, when the alignment print section 120 includes a plurality of alignment spacer recesses AH having a dot shape and being spaced apart from each other, the spacers 30 are prevented from being tilted to a side by a filling blade. As a result, the outline of the alignment mark 210 may become relatively clear and unambiguous. Therefore, a target substrate may be precisely aligned with respect to an alignment plate stage.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A print plate comprising:
a surface including a central region and a peripheral region surrounding the central region;
a panel print section including a plurality of panel spacer recesses disposed in the central region; and
an alignment print section including a plurality of alignment spacer recesses disposed in the peripheral region, the alignment spacer recesses being spaced apart from each other.

2. The print plate of claim 1, wherein the alignment spacer recesses are arranged along a first direction and a second direction crossing the first direction.

3. The print plate of claim 2, wherein the first and second directions are substantially perpendicular to each other.

4. The print plate of claim 3, wherein the alignment spacer recesses are arranged in a cross shape.

5. The print plate of claim 4, wherein the alignment print section further comprises a central spacer recess formed at a center of the cross shape.

6. The print plate of claim 3, wherein the alignment spacer recesses are formed along a plurality of lines in the first direction and along a plurality of lines in the second direction.

7. The print plate of claim 1, wherein each of the alignment spacer recesses has a dot shape.

8. The print plate of claim 7, wherein the dot shape is circular or tetragonal.

9. The print plate of claim 1, wherein the surface has a rectangular shape, and the alignment print section is formed in at least two corners of the surface having the rectangular shape.

10. The print plate of claim 1, wherein each of the alignment spacer recesses has substantially the same size as each of the panel spacer recesses.

11. A spacer-printing apparatus comprising:
a print plate comprising:
a surface including a central region and a peripheral region surrounding the central region;
a panel print section including a plurality of panel spacer recesses disposed in the central region; and
an alignment print section including a plurality of alignment spacer recesses disposed in the peripheral region, the alignment spacer recesses being spaced apart from each other;
an alignment plate disposed adjacent to the print plate;
a print roller that rolls on the print plate and the alignment plate to print spacers received in the alignment spacer recesses of the print plate onto the alignment plate to form an alignment mark on the alignment plate; and
a position-storing unit disposed over the alignment plate, the position-storing unit storing a position of the alignment mark.

12. The spacer-printing apparatus of claim 11, wherein the alignment spacer recesses are arranged along a first direction and a second direction crossing the first direction.

13. The spacer-printing apparatus of claim 11, further comprising:
a print plate stage that supports the print plate; and
an alignment plate stage that supports the alignment plate.

14. The spacer-printing apparatus of claim 11, wherein the position-storing unit comprises at least one camera for taking a picture of the position of the alignment mark.

15. A method of printing a spacer, comprising:
forming an alignment mark including a plurality of spacer dots on an alignment plate;
storing a position of the alignment mark;
aligning a target substrate by using the position of the alignment mark; and
printing spacers received in panel spacer recesses of a print plate onto the target substrate.

16. The method of claim 15, wherein forming the alignment mark, comprises:
filling alignment spacer recesses of the print plate with spacers; and
rolling a print roller on the print plate and the alignment plate to print the spacers in the alignment spacer recesses onto the alignment plate to form the alignment mark.

17. The method of claim 15, wherein storing the position of the alignment mark, comprises:
taking a picture of the position of the alignment mark and storing the position of the alignment mark.

18. The method of claim 17, wherein aligning the target substrate, comprises:
separating the alignment plate from an alignment plate stage;
loading the target substrate onto the alignment plate stage; and
aligning the target substrate so that a target alignment mark on the target substrate coincides with the stored position of the alignment mark.

19. The method of claim 15, wherein printing the spacers comprises:
filling the panel spacer recesses of the print plate with the spacers; and
rolling a print roller on the print plate and the target substrate to print the spacers in the panel spacer recesses of the print plate onto the target substrate.

20. The method of claim 15, wherein the alignment spacer recesses are arranged along a first direction and a second direction crossing the first direction.
